(19) United States
(12) Patent Application Publication
(10) Pub. No.: US 2009/0231855 A1
(43) Pub. Date: Sep. 17, 2009

(54) UNIFORM WASH LIGHTING FIXTURE AND LENS

(76) Inventors: Gregg Esakoff, Whitefish, MT (US); David Kinzer, Baraboo, WI (US)

Correspondence Address: GREER, BURNS & CRAIN, LTD., Suite 2500, 300 South Wacker Drive, Chicago, IL, 60606, US

(21) Appl. No.: 12/403,637

(22) Filed: Mar. 13, 2009

Related U.S. Application Data
(60) Provisional application No. 61/069,259, filed on Mar. 13, 2008.

(51) Int. Cl. F21V 7/06; F21V 7/00; G02B 27/10

(52) U.S. Cl. 362/296.08; 362/296.01; 359/627

(57) ABSTRACT

A parabolic aluminized reflector (PAR) lighting fixture is provided with a faceted lens having many distinct lens elements. A plurality of first lens elements use light refraction to direct light from the collimated beam supplied from the fixture reflector to uniformly illuminate segments of a region of an adjacent wall surface. A plurality of second lens elements use internal reflection to direct light from the collimated beam to uniformly illuminate other, off-axis segments of the region. The resulting highly asymmetric beam distribution pattern provides wall wash or cyc capability with a widely available PAR fixture and eliminates the need for dedicated cyc or wall wash fixtures.

### PRIORITY CLAIM AND REFERENCE TO RELATED APPLICATION

This application claims the benefit of U.S. Provisional Application Ser. No. 61/069,259, filed Mar. 13, 2008, under 35 U.S.C. § 119 and 35 U.S.C. § 120.

### FIELD OF THE INVENTION

The present invention relates to an improved wash lighting fixture, e.g., curtain, cyclorama (cyc), scrim, wall or other surface.

### DESCRIPTION OF THE PRIOR ART

In lighting applications such as stage and studio and architectural lighting, there is a need for lighting fixtures capable of washing a curtain, cyclorama (cyc), scrim, wall or other vertical surface with light. Preferably, the surface should be evenly illuminated over the lighted region, and vertical and horizontal gradations in intensity should be minimized. To avoid complexity, and to prevent obstruction when the fixtures are supported on or above a floor, the fixtures should be placed relatively close to the vertical surface to be illuminated. This exacerbates the problem of achieving uniform illumination, particularly in the vertical direction.

PAR (parabolic aluminized reflector) lighting fixtures are widely used in theatres, studios and the like and are readily available for use in lighting applications. A PAR fixture includes a lamp supported in a housing with a parabolic reflector that directs light, often through a lens, to project a generally collimated, cylindrical (typically circular or oval) beam of light. U.S. Pat. Nos. 1,466,358 and 4,285,034 disclose examples of PAR fixtures with refraction lenses. Often a PAR fixture has a fixed lens that refracts light passing through the lens. Successful modern PAR fixtures may have a removable lens, and such fixtures have been provided with replaceable lenses having different refraction characteristics for different purposes. Lenses available for PAR fixtures include lenses with different fixed beam angles and zoom lenses for continuous variation of the light beam dispersion angle. None of the known types and variations of PAR fixtures is suited for cyc or wall wash applications. They are not capable of projecting highly asymmetrical, uniformly distributed light over a vertical region. As a result, dedicated cyc or wash fixtures are required.

Conventional cyc or wall wash lighting fixtures are special purpose, dedicated fixtures not well suited for other purposes. Normally, this type of fixture includes one or more rectangular lighting units relying on reflectors of special design to spread and direct light over a nearby vertical region to be illuminated. U.S. Pat. No. 1,350,295 discloses an example of a special purpose wall wash fixture. A studio or stage or other venue typically must have cyc or wall wash fixtures in addition to the widely used PAR fixtures.

### SUMMARY OF THE INVENTION

A primary object of the invention is to provide a lighting fixture that can function as a PAR fixture or a cyc fixture simply by replacing the lens. Another object is to provide a lens for a PAR fixture that uses both refraction and total internal reflection (TIR) for projecting uniform light over a wall surface such as a wall, cyc, curtain or the like.

In brief, in accordance with the present invention, there is provided a lighting fixture for illuminating a wall surface. The lighting fixture includes a housing having an axis and a light source in the housing. A reflector in the housing has a concave shape of a surface of revolution for directing light reflected from the light source in a generally collimated beam in the direction of the axis. A lens is supported by the housing in the path of the beam. The lens includes a plurality of lens elements transforming the collimated beam into an illumination pattern for generally uniformly illuminating a region of the wall surface.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a simplified schematic diagram of an example lighting fixture constructed in accordance with the present invention;

FIG. 2 is an elevational view of a wall surface and a floor mounted PAR fixture showing the light beam distribution produced by a typical prior art PAR fixture used in a wall wash or cyc application;

FIG. 3 is a view like FIG. 2 illustrating the light beam distribution produced by an example fixture of the present invention in the same application;

FIG. 4 is a front elevational view of the lens of the fixture of FIG. 3.

FIG. 5 is an enlarged, fragmentary cross sectional view taken along the line 5-5 of FIG. 4 and showing selected lens elements of the lens of FIG. 4;

FIG. 6 is an elevational view illustrating light beam distributions produced by example fixtures of the present invention in different fixture positions;

FIG. 7 is a perspective view of a stage having a wall surface illuminated by example fixtures of the present invention;

FIG. 8 is a front view of a preferred embodiment lens of the invention;

FIG. 9 illustrates a preferred facet arrangement for the lens of FIG. 8;

FIGS. 10A-10C illustrate illumination patterns of the facets of FIG. 9;

FIGS. 11A-11C show measured illumination patterns for respective bottom placed fixture, top placed fixture, and combined bottom and top placed example fixtures of the invention, respectively;

FIG. 12A illustrates an illumination pattern from the combination of a floor mounted fixture and ceiling (or support) mounted fixture of the invention; FIG. 12B illustrates an illumination pattern of an example floor mounted fixture and a typical reflector-based cyc light; FIG. 12C illustrates the combined illumination pattern from one reflector-based cyc light on the floor and a second reflector-based cyc light mounted on the ceiling;

FIG. 13A is the illumination pattern from an example fixture of the invention set 4 feet from a surface; FIG. 13B is the illumination pattern from 3 example fixtures of the invention set 4 feet from a surface and spaced apart by 7.5 feet; FIG. 13C is the illumination pattern from a typical reflector-based fixture set 4 feet from a surface; FIG. 13D is the illumination pattern from three typical reflector-based fixtures set 4 feet from a surface and spaced apart by 8.5 feet; and

FIGS. 14A and 14B are respective front and side views of a typical parabolic fixture retrofitted with a lens of FIGS. 8 and 9 to form a preferred embodiment fixture of the invention.

### DETAILED DESCRIPTION OF THE PREFERRED EMBODIMENT

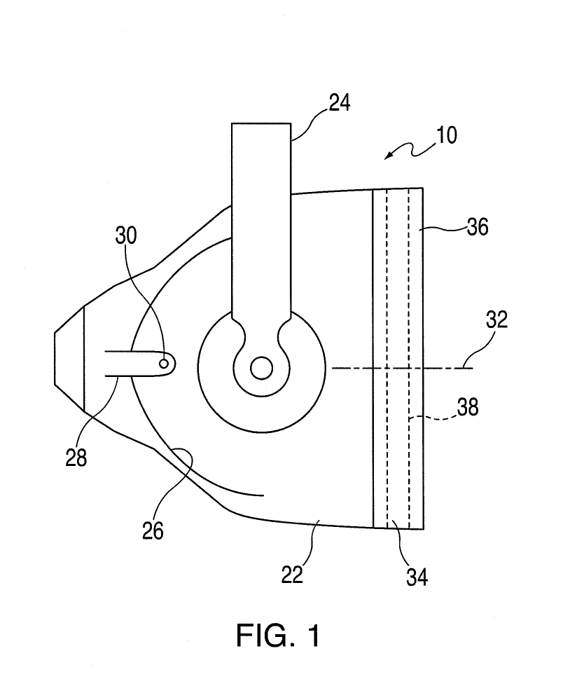

Having reference now to the drawings, in FIG. 1 there is illustrated in simplified, schematic fashion a lighting fixture generally designated as 10 and constructed in accordance with the principles of the present invention. The fixture 10 of the illustrated embodiment of the invention is a parabolic aluminized reflector (PAR) fixture. It includes a housing 22 that may be provided with a yoke 24 for mounting the fixture 10. Contained within the housing 22 is a reflector 26, e.g., a concave reflector that is typically in the shape of a conic surface of revolution, and specifically a parabola.

A lamp 28 supported in the housing 22 provides a concentrated source 30 of light, for example a filament or filament array, located at the focus of the (e.g., parabolic) reflector. Light emitted from the source 30 is reflected from the reflector 26 in a collimated light beam in the form of a right circular cylinder. The light beam, the reflector 26 and the housing 22 share a central axis 32.

In accordance with the present invention the lighting fixture 10 is provided with a lens structure 34. The lens structure 34 includes a circular peripheral frame 36 positioned at the front end of the housing 22. The frame 36 supports a lens 38 that is specially constructed and arranged to convert the collimated circular light beam from the reflector 26 into an entirely different, highly asymmetrical beam distribution pattern that is optimized for washing a wall surface with light. The beam distribution pattern achieved with the lens 38 is able to provide highly uniform illumination of an extended region of a wall surface.

Definition. The term “wall surface” is used here to mean a surface that is adjacent to a fixture used for illuminating that surface, and can be a wall, a backdrop, a cyc screen, a scrim, an element of stage or studio scenery or any similar surface to be illuminated by an adjacent lighting fixture.

Except for the lens structure 34, the fixture 10 may be identical to a known PAR fixture, such as the SOURCE FOUR™ lighting fixtures sold by Electronic Theatre Controls, Inc. of Middleton, Wis., U.S.A. Such known fixtures may be provided with removable and replaceable lens structures of various types such as refracting lens for various fixed beam angles and adjustable beam angles. However, known PAR fixtures and lenses are not suited for wall wash or cyc applications.

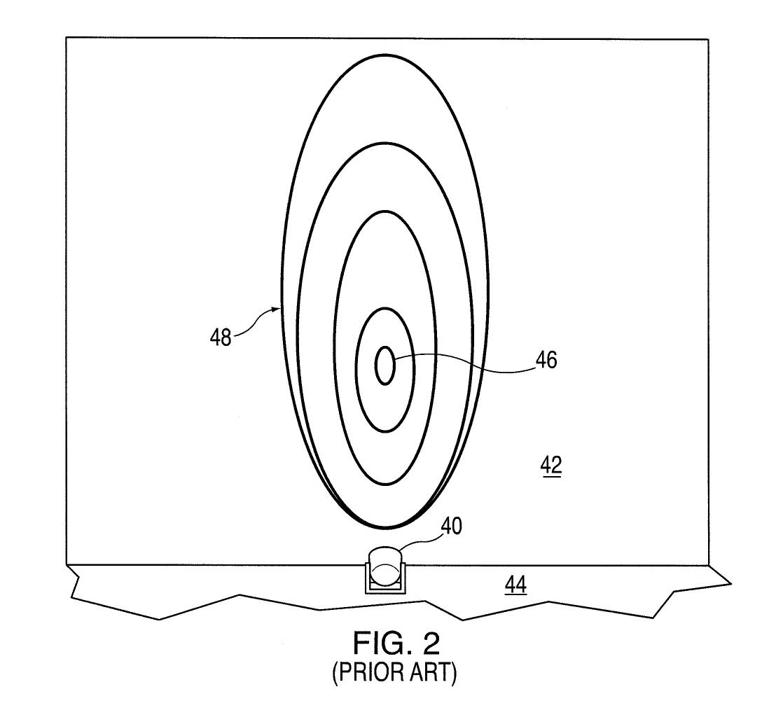

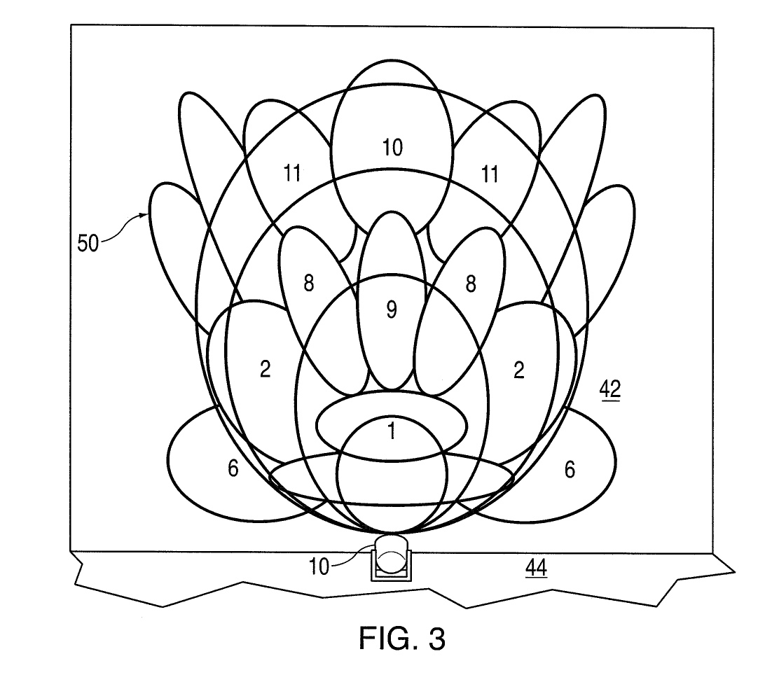

For example, FIG. 2 is an illustration of a known PAR fixture 40 used to illuminate a wall surface 42. The fixture 40 is supported on a floor surface 44 perpendicular to the wall surface 42, and is positioned adjacent to the wall surface 42, typically about three to six feet from the wall surface 42. The light beam axis of the fixture 40 is inclined from vertical and toward the wall surface 42 at an angle of about seventy degrees. The central axis of the light beam from the fixture 40 strikes the wall surface 42 at a point 46 about eight or nine feet above the floor surface 44. The illumination of the wall surface 42 is not uniform. Rather, the illumination pattern 48 on the wall surface can be described as generally conical. This beam distribution pattern 48 is not suitable for wall wash or cyc applications where a more uniform illumination of a large and generally rectangular wall region is needed.

FIG. 3 is a view similar to FIG. 2 showing the fixture 10 of the present invention mounted on the floor surface 44 and illuminating the wall surface 42. In place of the conical beam distribution pattern 48 of FIG. 2, the beam distribution pattern 50 produced by the fixture 10 is generally rectangular and is generally uniform in light intensity throughout the illuminated region of the wall surface 42. This beam pattern 50 is optimized to be effective as a wall wash or cyc pattern.

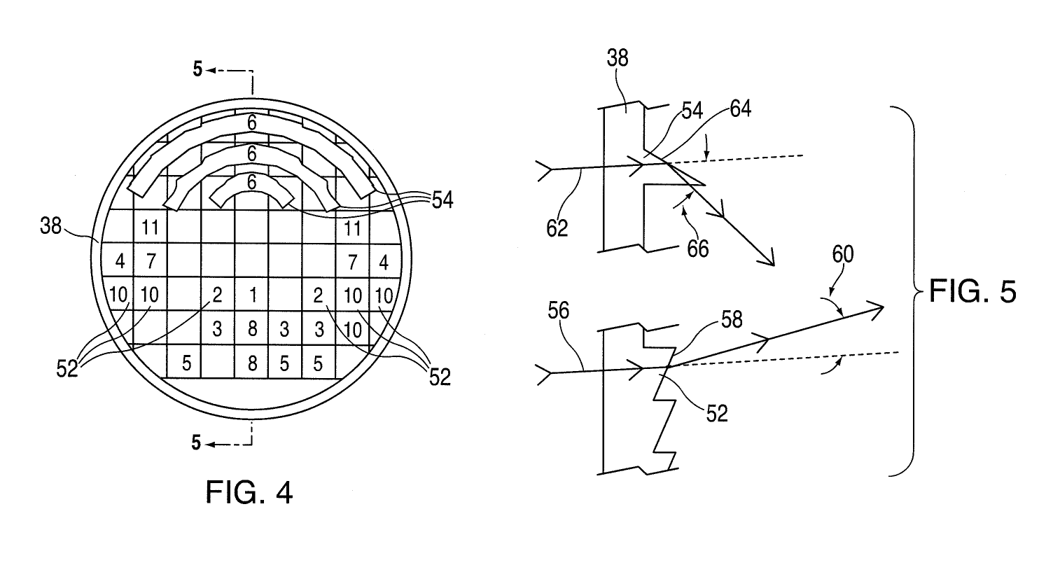

FIG. 4 is a front elevational view of the lens 38 of the example fixture 10, with a zonal map overlaid thereon for purposes of clarity. In accordance with the invention it is a faceted array of many distinct lens elements. These lens elements include a plurality of first lens elements 52 and one or more, and preferably a plurality, of second lens elements 54. The lens elements 52 and 54 convert the collimated, generally circular cylindrical light beam from the reflector 26 of the fixture 10 into the beam distribution pattern 50 seen in FIG. 4.

An example first element 52 and an example second element 54 are seen in greatly enlarged cross section in FIG. 5. Element 52, a refracting element, functions by refracting a light beam 56 passing through the lens 38. Front lens surface 58 is disposed at an angle to the axial beam direction, and the light beam 56 is redirected by refraction at the lens surface 58 and leaves the lens 38 at an angle 60 to the axial direction. Changing the direction of the slope of the front surface 58 of element 52 will change the deflection angle 60 from positive (up) to negative (down) where needed.

The refractive lens elements 52 are preferably not all identical to one another, but instead are constructed and arranged to uniformly wash and fill segments of the beam pattern 50 with light. In FIG. 4, the first lens elements are identified by reference numerals 2, 3, 4, 5, 7, 8, 9, 10 and 11 on the zonal map. In the beam distribution pattern 50 seen in FIG. 3, the same reference numerals designate the portions of the beam distribution pattern 50 illuminated by the corresponding first lens elements 52. For example, the lens elements 52 designated as 2 refract light in the columnar beam from the reflector 26 in a direction and at an angle 60 in order to illuminate the regions 2 in the beam pattern 50 of FIG. 3. Similarly, the other first lens elements are configured to illuminate the corresponding regions of the beam distribution pattern 50.

The ability of lens refraction to efficiently redirect light decreases as the refraction angle 60 increases. For example, the first, refracting lens elements 52 are effective to transmit and refract light in directions along and relatively close to the beam axis. However, when the refraction angle is greater than a relatively small angle, e.g., when the refraction angle exceeds about forty degrees, the first, refracting lens elements 52 are not capable of redirecting light efficiently into the beam distribution pattern 50. In accordance with embodiments of the invention, the second lens elements 54 are employed for highly off-axis illumination. Example second lens elements 54 transmit and reflect light in off-axis directions diverging at relatively large angles (e.g., greater than 40 degrees) from the beam axis.

As seen in FIG. 5, the example second lens element 54, which is an internally reflective element such as a total internal reflection (TIR) element, functions by internally reflecting a light beam 62 passing through the lens 38. Reflective lens surface 64 is disposed at an angle to the axial beam direction, and intercepts the light beam 62 after it enters the lens 38. The light beam is reflected at the lens surface 64 and leaves the lens 38 at an angle 66 to the axial direction.

Reflection angles 66 well in excess of forty degrees can be achieved by the internally reflective second lens elements 54, and these elements are useful for illuminating off-axis regions of the beam distribution pattern 50. In FIG. 4, second lens elements 54 are designated by the reference numeral 6. In the beam distribution pattern 50 shown in FIG. 3, the off-axis areas illuminated by the second lens elements 54 are designated by the corresponding reference numeral 6. Refractive and reflective lens elements 52 and 54 of the faceted lens 38 are designed to uniformly illuminate the entire beam distribution pattern 50.

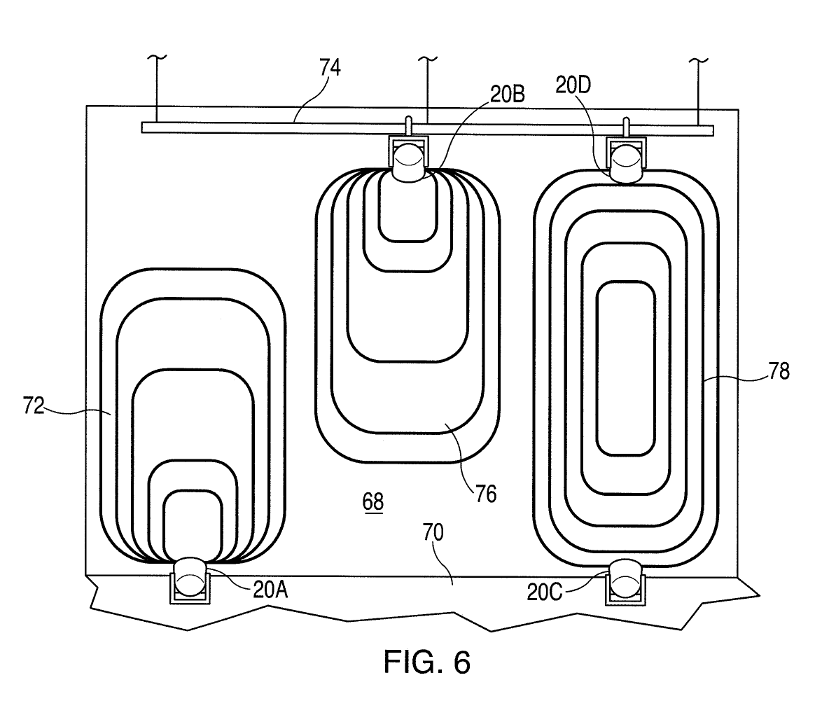

FIG. 6 is a drawing showing illumination of regions of a wall surface 68 by example fixtures 20A, 20B, 20C and 20D of the present invention. Fixture 20A is supported on floor surface 70 and provides a beam distribution pattern 72 like the pattern 50 (iso-illuminance) seen in FIG. 3. Fixture 20B is mounted overhead on a support frame 74 and provides a beam distribution pattern 76 that is like the pattern 72 but inverted. Thus, fixtures 20A and 20B provide example beam distribution patterns 72, 76 where the fixtures are mounted either on the floor surface 70 or an overhead support frame 74, respectively. Fixtures 20C and 20D are mounted in alignment with one another on the floor 70 and frame 74, respectively, and combine to produce a beam distribution pattern 78 that uniformly illuminates a region of the wall surface 68 of substantial height. The combination pattern 78 is useful for lighting wall surfaces of stages and studios (for example) that may be of substantial vertical extent.

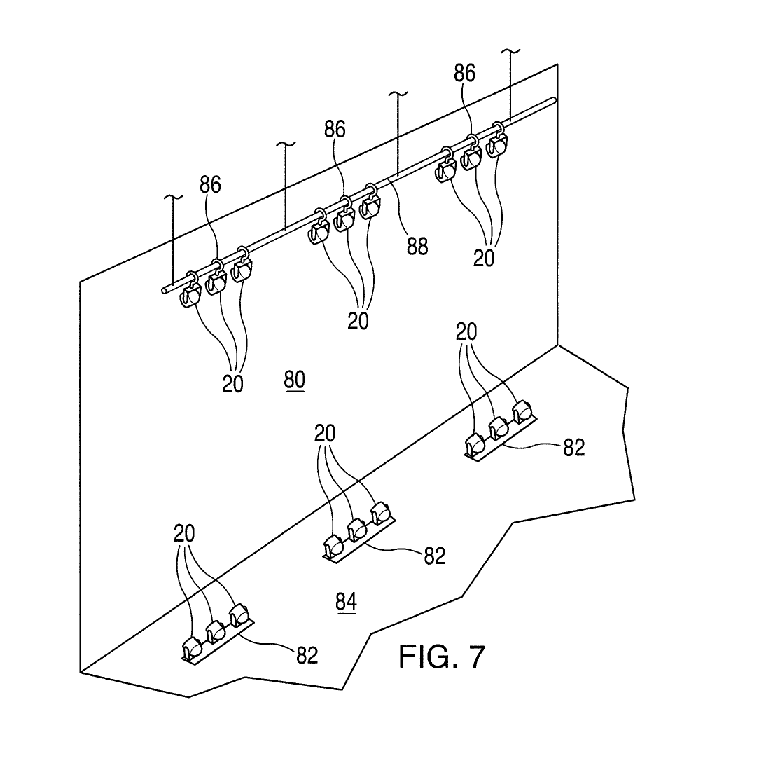

FIG. 7 is a perspective view of an exemplary installation of a number of lighting fixtures 20 for a theatrical lighting installation using wall or cyc lighting. The fixtures 20 are positioned to illuminate a wall surface 80 that may be, for example, a cyc screen, scrim, wall, backdrop or element of scenery. The fixtures 20 can be placed front stage (in front) of the wall surface 80. If the wall surface 80 is translucent, the fixtures 20 can be positioned back stage (in back) of the wall surface 80. The fixtures 20 can be offset from the wall surface 80 by, for example, four to eight feet. The example wall surface 80 has a height of up to about 40 feet, though the wall surface height can vary for particular fixtures or groups, environments applications, etc.

Groups 82 of the fixtures 20 are mounted on floor surface 84, e.g., a stage floor, and other groups 86 of the fixtures 20 are mounted on an overhead support frame 88. Groups may include one to four fixtures 20, though it is also possible to have more than four fixtures in a group. Each group 82 and 84 may include fixtures 20 providing white light and fixtures with gels for providing different colors (e.g., three colors, plus white). This array of fixtures in groups can be controlled to achieve a great variety of wall wash or cyc lighting effects.

As will be apparent to artisans, preferred fixtures of the invention achieve generally uniform illumination patterns even when spaced close, e.g., 3 feet, to a surface being illuminated, and with a high angle of illumination, e.g., up to 70 degrees. This conserves high valuable space that is often wasted to place typical prior fixtures at sufficient distance away from a surface being illuminated to achieve a sufficient amount of uniformity. Combinations of fixtures of the invention produce high uniformity, as well. An advantage of certain embodiments of the present invention is that a fixture, such as but not limited to a PAR fixture, that may not otherwise be suitable for wall washing or cyc applications, can be made suitable by providing a lens structure according to example embodiments of the invention. Thus, in an example embodiment, a prior PAR fixture is fitted with a lens to produce a lighting fixture of the invention.

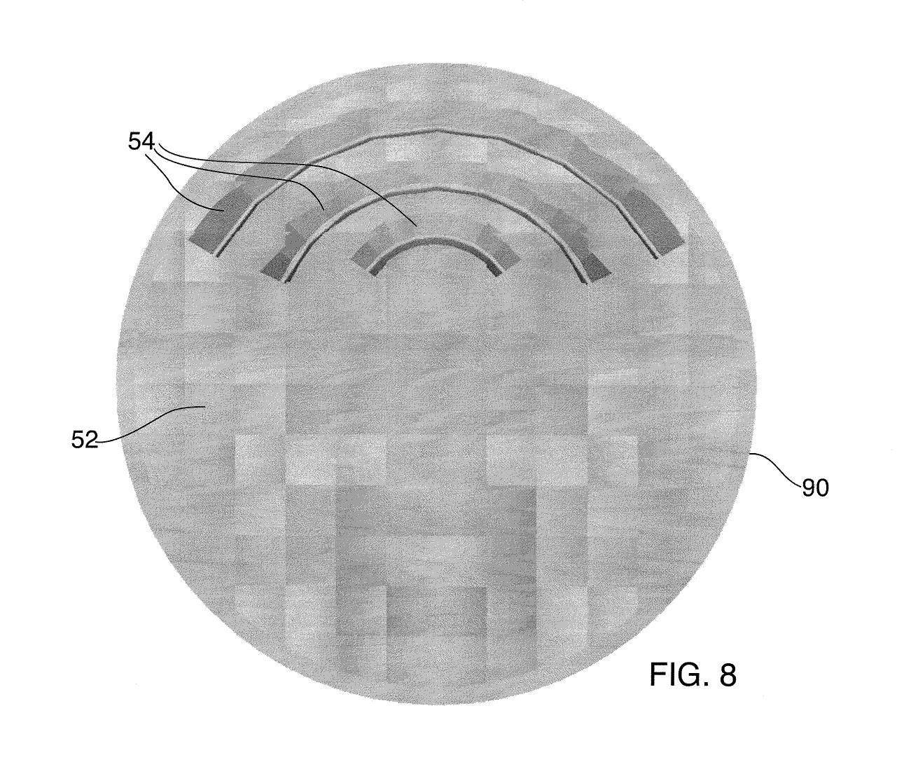

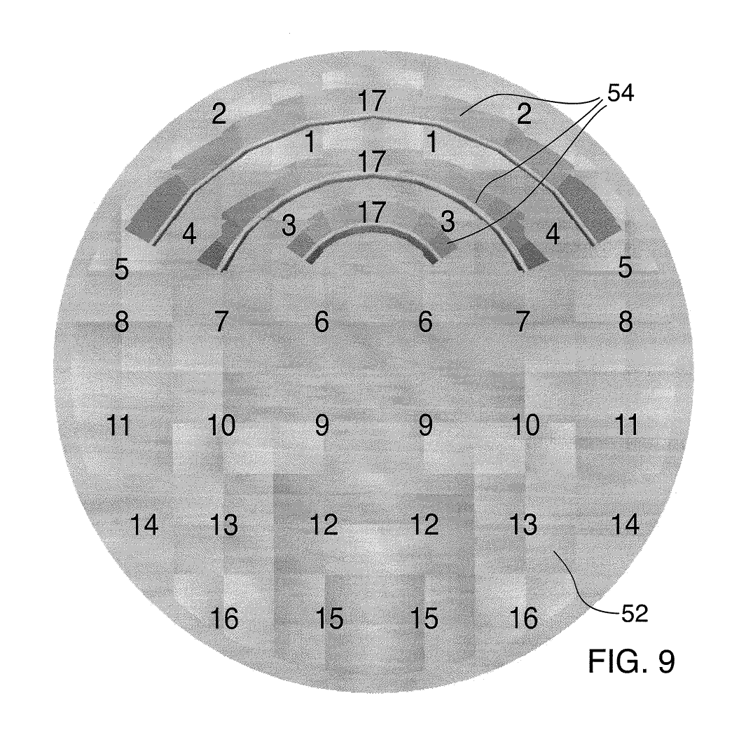

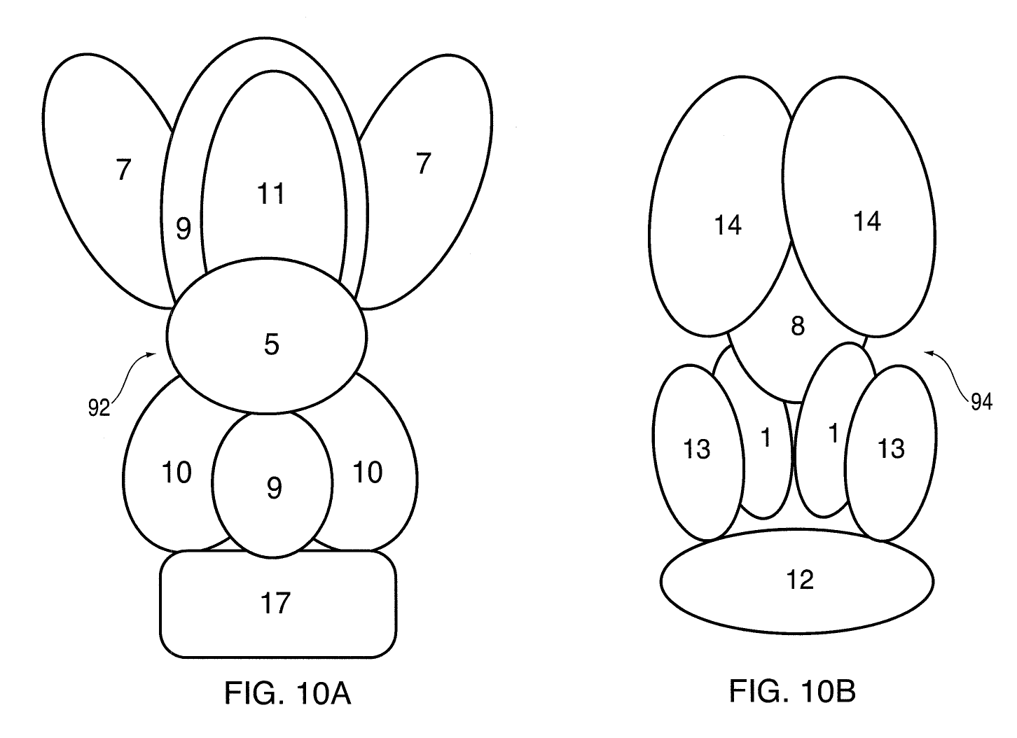

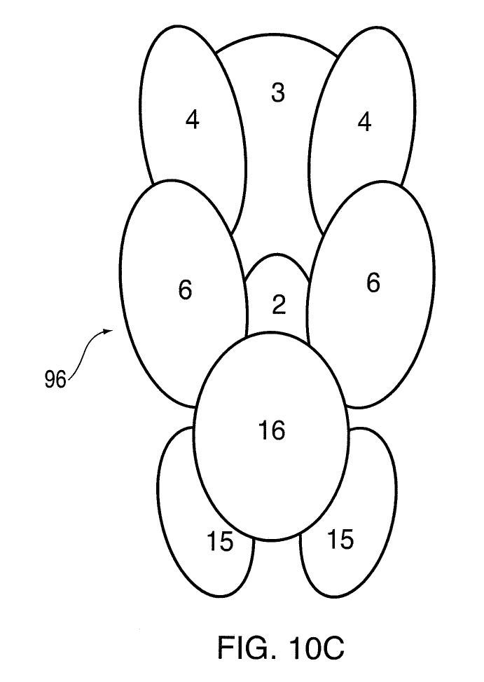

FIGS. 8 and 9 show more particular features of a lens 90 for a parabolic fixture according to an embodiment of the present invention. The lens 90 includes a plurality of first elements 52, including refractive facets, and a plurality of second elements 54, which preferably are embodied in TIR elements. Individual facets of first elements 52 can be generally configured and classified according to X tilt, Y tilt, X curvature, and Y curvature parameters. Facets of individual second elements 54 can be generally configured and classified according to Y tilt, Y curvature, Z tilt, and Z curvature parameters. In the example facet arrangement for the lens 90 of FIGS. 8 and 9, different combinations of these parameters are illustrated by different shadings.

As shown by the zonal map in FIG. 9, common numbers indicate groupings of similar facets. For example, the four facets making up both groups numbered 9 for the first elements 52 are similarly shaped (and symmetrical with respect to the vertical centerline in the zonal map). In the same way, the groups numbered 17 for the second elements 54 have a largely similar pattern from left to right in FIG. 9 (also symmetrical with respect to the centerline).

For a particular application, lenses in accordance with the principles embodied in the lenses 90 of FIGS. 8 and 9 can be designed to creating a smooth light pattern by a multi-step process using optical design software. An example optical design software known in the art is Zemax.

Each facet making up the individual first elements 52 has a spherical or aspheric shape defined by a group of parameters that may be varied. Similarly, each facet making up the individual second elements 54 has an aspheric shape defined by a group of parameters that may be varied. The prescription of the facets should be adjusted to achieve several goals: uniform illumination over an area (as a non-limiting example, an 8′ wide by 20′ high area), smooth blending for multiple fixtures, and maximum efficiency. This can be accomplished by an iterative process, known to practitioners of the art, of tracing a sufficient number of rays and evaluating the results of a simulated light pattern until the goals are met. In the finished design, the first elements 52 may be all identical, or some may have one prescription and others a different prescription, or all elements may have their own unique prescription.

FIG. 10A shows an example first illumination pattern 92 for the lens 90 shown in FIGS. 8 and 9 that is caused by refractive facets in groups 5, 7, 9, 10, and 11, as well as TIR facets in group 17. For example, the facets in group 10 in FIGS. 8 and 9 create the portions of the illumination pattern 92 marked 10. Similarly, FIG. 10B shows an example second illumination pattern 94 that is caused by refractive facets in groups 1, 8, 12, 13, and 14. FIG. 10C shows an example third illumination pattern 96 that is caused by refractive facets in groups 2, 3, 4, 6, 15, and 16. These illumination patterns 92, 94, 96 are merely examples, as such illumination patterns can vary based on the particular respective configuration of the first and second lens elements 52, 54.

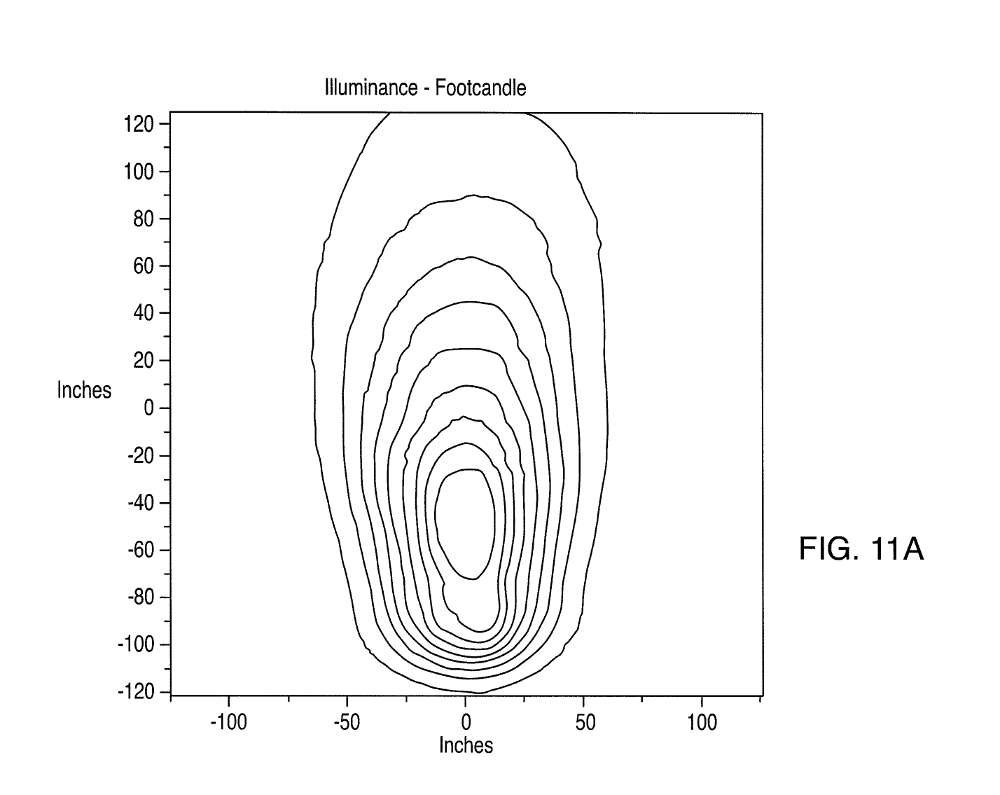

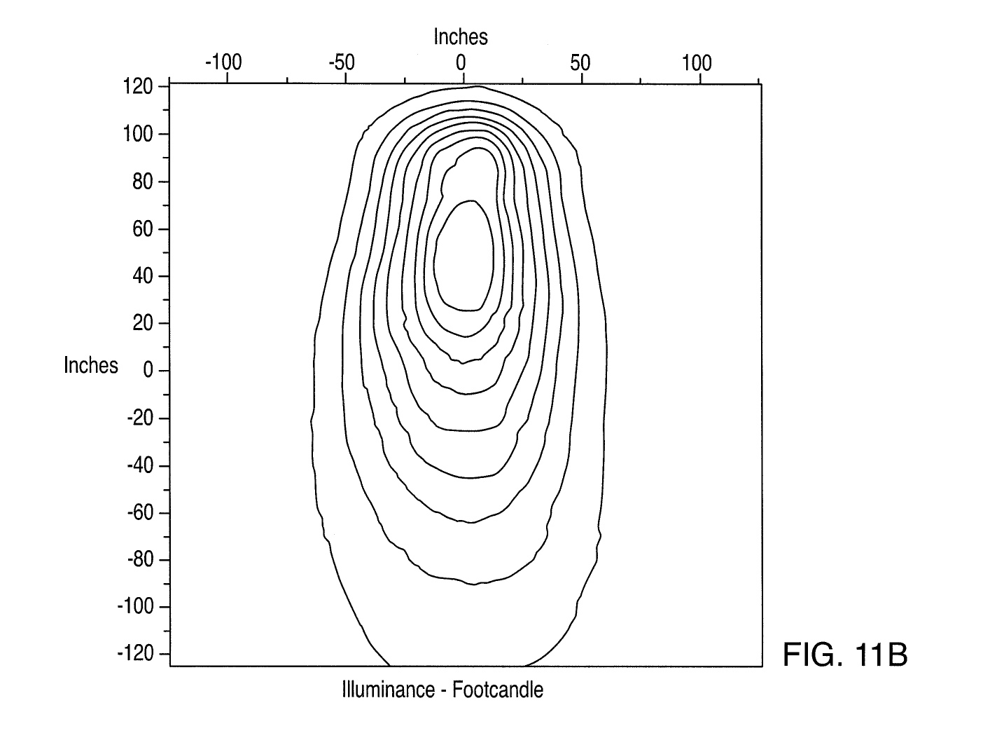

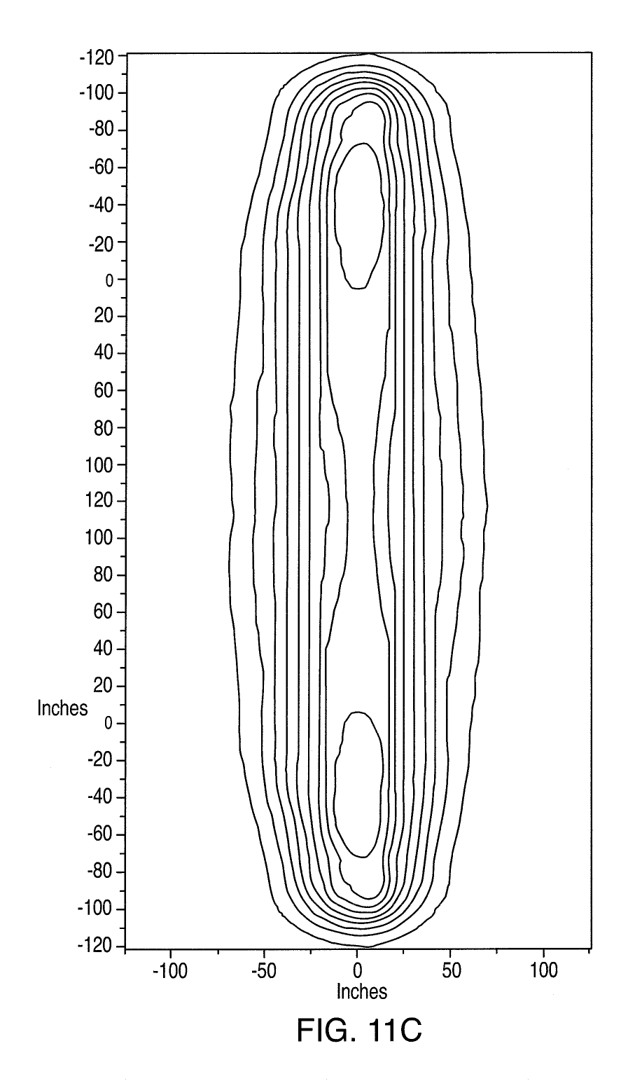

The illumination patterns 92, 94, 96 combine to form a uniform wash, even when a fixture is close to a surface being illuminated. FIG. 11A shows a measured photometric pattern from an example lens according to the present invention (such as lens 90) fitted into a fixture placed at a bottom of a surface being illuminated. FIG. 11B shows a measured photometric pattern from an example lens fitted into a fixture placed at a top of a surface being illuminated. FIG. 11C shows a combined measured photometric pattern from example lenses fitted into fixtures placed at a bottom and a top of a surface being illuminated. As shown, the example lens provides a uniform wash from either the bottom or top of the surface to be illuminated, and the combination of bottom and top fixtures produces a uniform wash across the entire vertical surface.

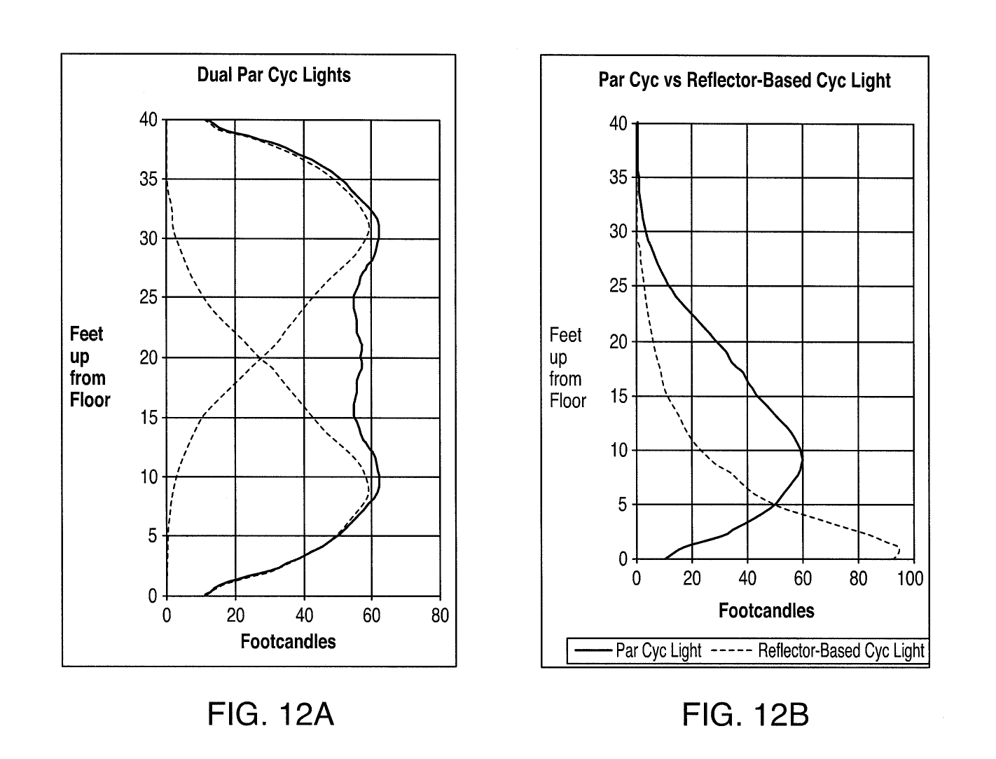

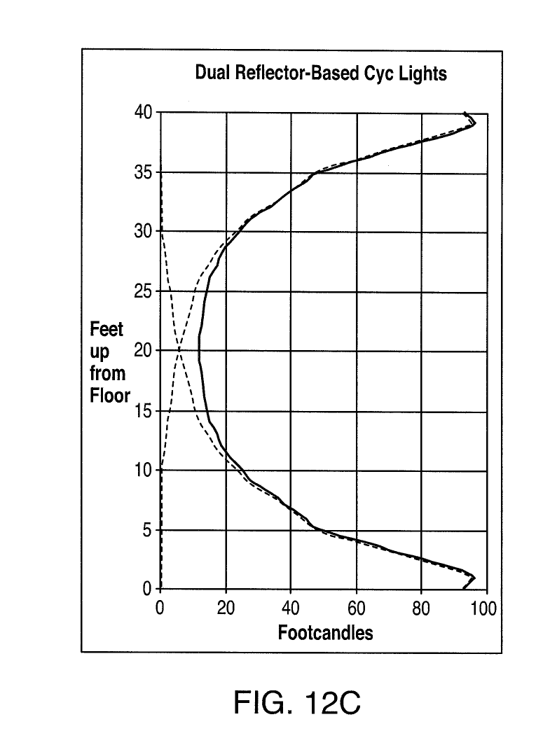

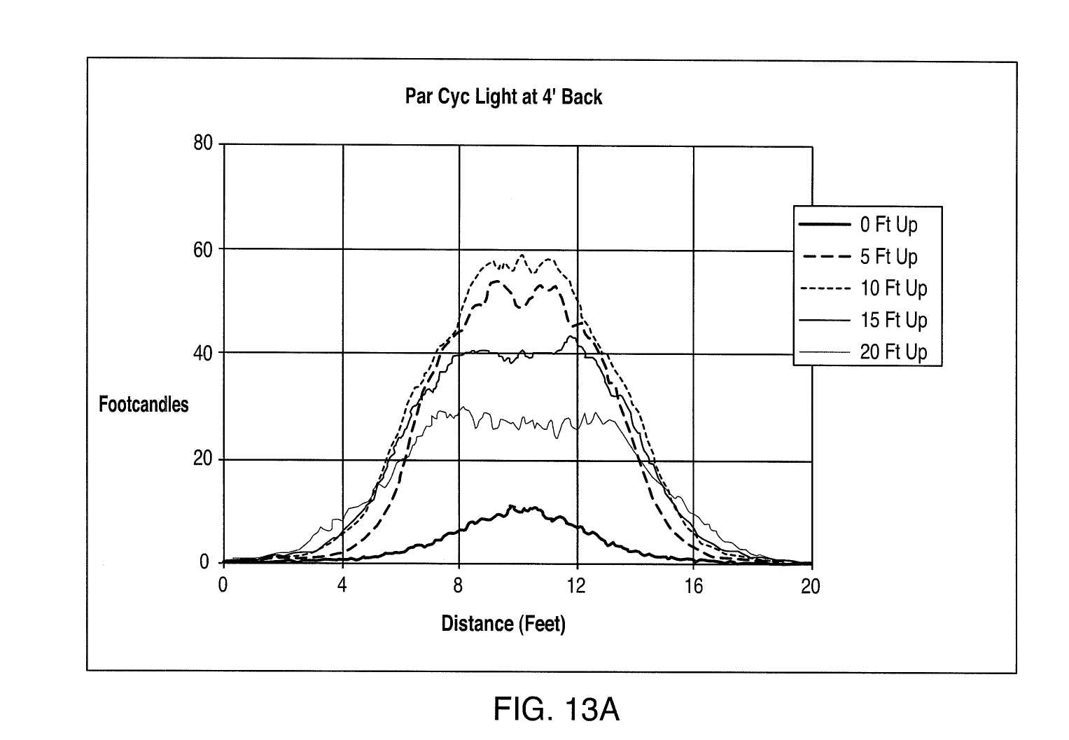

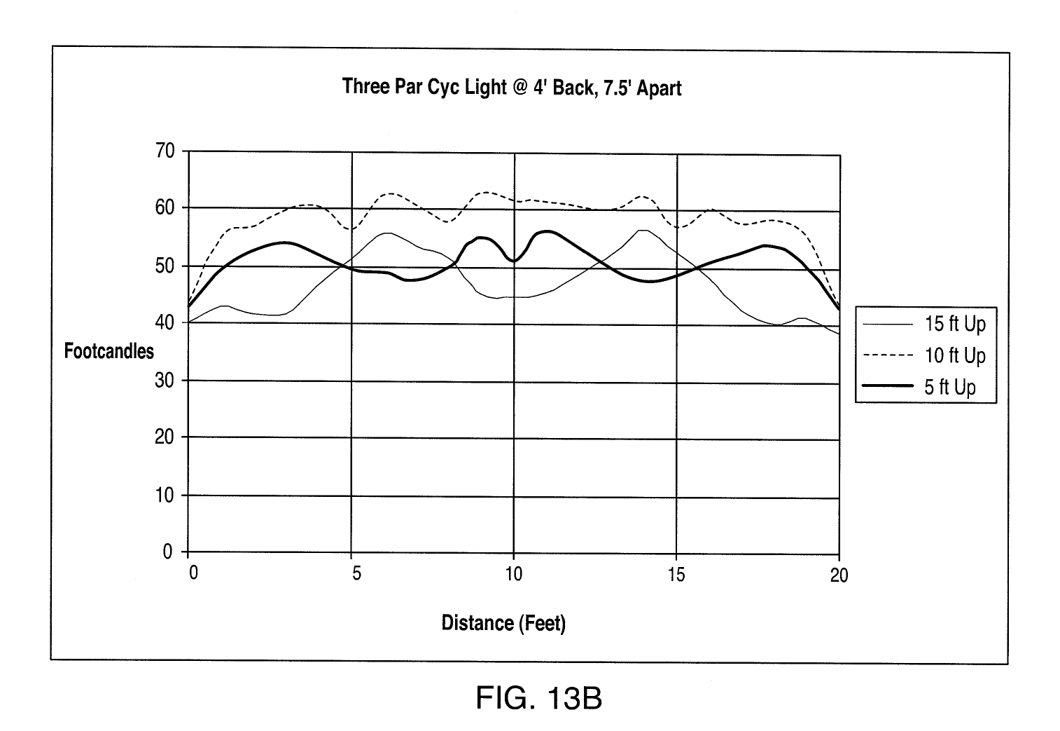

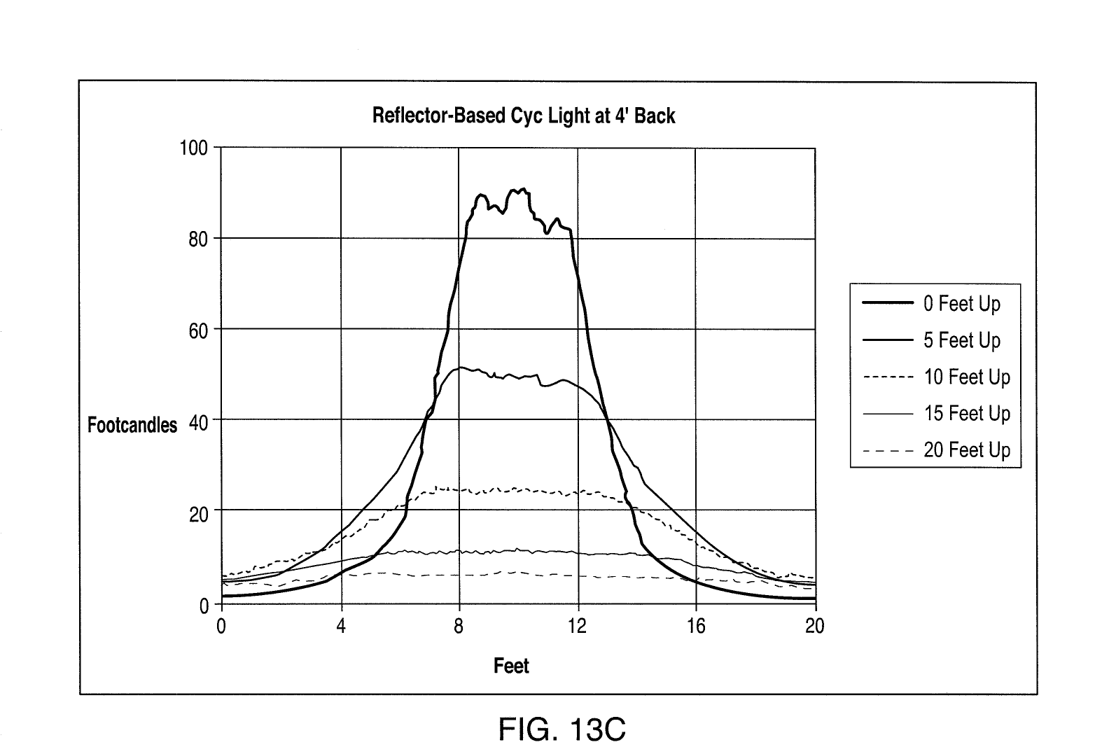

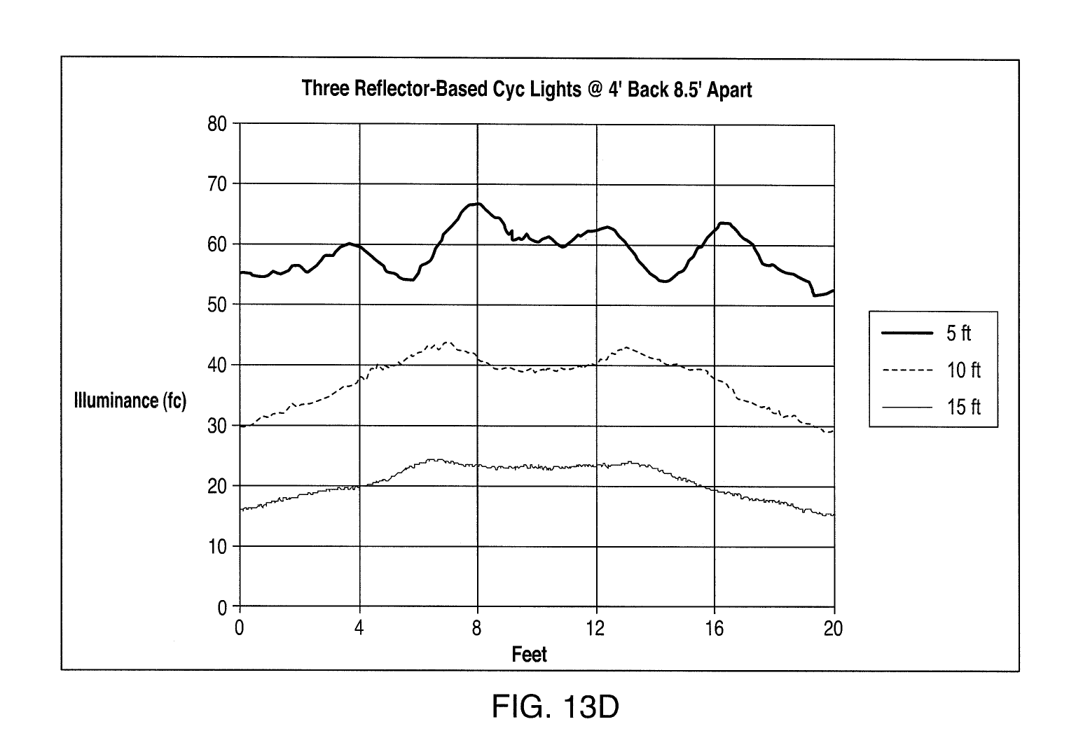

Given the determined lens facet layout, the lens 90 can be manufactured and fitted into a lighting fixture, including but not limited to a PAR fixture, for wall wash or cyc applications. PAR fixtures fitted with an example lens of the present invention (such as lens 90) are compared to a conventional reflector-based cyc light fixture in FIGS. 12A-12C and 13A-13D. FIG. 12A shows the illuminance along the vertical centerline for dual parabolic fixtures (referred to in FIG. 12A as “par cyc lights”), where one is mounted to floor and one to ceiling, having lenses according to an embodiment of the present invention. In FIG. 12A, the dashed line indicates illumination of individual fixtures, and the solid line shows the combined illumination. FIG. 12B illustrates an illumination pattern from a floor (solid line) mounted fixture compared to a typical reflector-based cyc light mounted in the same way. FIG. 12C shows an illumination pattern of dual reflector cyc lights that are floor-mounted and ceiling-mounted, where the dashed line indicates illumination of individual fixtures, and the solid line shows the combined illumination. FIGS. 12A-12C show that the parabolic fixtures fitted with lenses according to embodiments of the present invention provide significantly more uniform illumination along a vertical surface.

FIGS. 13A-13D show the illuminance along horizontal lines at various heights for PAR fixtures fitted with lenses (such as lens 90) according to embodiments of the present invention and groups of such fixtures, as well as illumination patterns of a conventional cyc light fixture and groups of such fixtures. Particularly, FIG. 13A shows illumination patterns for a PAR fixture fitted with an example lens of the present invention set four feet from a vertical flat surface, while FIG. 13B shows illumination patterns for three such fixtures set four feet back from the vertical flat surface and spaced 7.5 feet from each other. For comparison, FIG. 13C shows illumination patterns for a conventional reflector-based cyc fixture set four feet back from the vertical flat surface, and FIG. 13D shows illumination patterns for three conventional reflector-based cyc fixtures four feet back from the vertical flat surface and spaced at 8.5 feet from each other. As shown in FIG. 13A-13D, PAR fixtures provided with lenses according to embodiments of the present invention provide significantly more uniform lighting across various heights along the vertical surface.

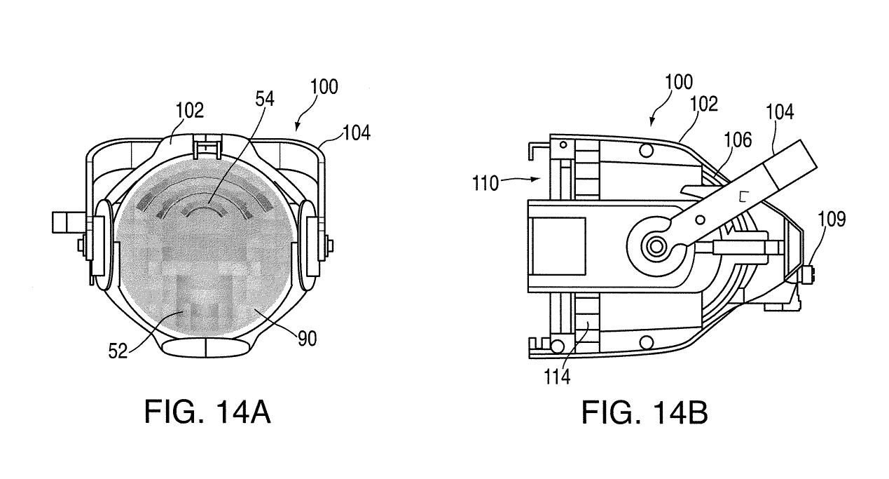

As shown in FIGS. 12A-12C and 13A-13D, an advantage of example embodiments of the present invention is that certain fixtures that heretofore were ineffective for wall wash or cyc applications can be made effective by providing a suitable lens as disclosed herein. For example, FIGS. 14A and 14B show front and side views, respectively, of an example PAR fixture 100 (e.g., a wash luminaire) that is fitted with a lens such as the lens 90 shown in FIGS. 8 and 9. The fixture 100 includes a housing 102, preferably made of a metal such as aluminum, and is provided with a yoke 104 for mounting. A reflector 106 is contained within the housing 102 in the shape of a conic surface of revolution, and specifically a parabola. A lamp (not shown in FIGS. 14A-14B), for example a filament or filament array, supported in the housing 102 provides a concentrated source of light, located at the focus of the reflector 106. A suitable electrical coupling 109 provides a power supply for the lamp. For controlling a temperature of the reflector 106, a heat sink is preferably provided. A heat sink may also be provided for the lamp, for example at a lamp base.

The lens 90, preferably moulded borosilicate glass, may be supported by a lens structure 110 that is positioned at a front end of the housing 102 (e.g., the lens may be mounted in the lens structure). In some example embodiments a rotating ring 114, preferably thermally insulated, is provided for rotating the lens 90.

While the present invention has been described with reference to details of the embodiment of the invention shown in the drawings, these details are not intended to limit the scope of the invention as claimed in the appended claims.

What is claimed is:

1. A lighting fixture for illuminating a wall surface comprising:
a housing having an axis;
a light source in said housing;
a reflector in said housing having a concave shape of a surface of revolution for directing light reflected from said light source in a generally collimated in the direction of said axis;
a lens supported by said housing in the path of said beam;
the lighting fixture being characterized by:
said lens including a plurality of lens elements transforming said generally collimated beam into an illumination pattern for generally uniformly illuminating a region of the wall surface.

2. A lighting fixture as claimed in claim 1, said reflector having a parabolic shape.

3. A lighting fixture as claimed in claim 1, said plurality of lens elements including first elements that direct light toward portions of the wall surface that are at relatively small angles to said axis.

4. A lighting fixture as claimed in claim 3, said plurality of lens elements including second elements that direct light toward portions of the wall surface that are at relatively large angles to said axis.

5. A lighting fixture as claimed in claim 4, said first elements being refraction lens elements.

6. A lighting fixture as claimed in claim 5, said second elements being total internal reflection lens elements.

7. A lens for converting a generally collimated light beam having an axis into an asymmetrical light beam distribution for washing a wall surface, said lens comprising:
a generally circular array of lens elements;
said array including a plurality of first lens elements, each of said first elements being constructed and arranged to transmit and refract light in directions along and relatively close to the beam axis; and
said array including a plurality of second lens elements, each of said second lens elements being constructed and arranged to transmit and reflect light in off-axis directions diverging at relatively large angles from the beam axis.

8. The lens of claim 7, said second lens elements being internal reflection lens elements.

9. A wall wash or cyc lighting fixture for uniform illumination of a region of a wall surface adjacent to the fixture, the lighting fixture comprising:
a housing having an axis;
a reflector in said housing having a focus;
a light source positioned at the focus of said reflector;
said reflector being generally parabolic and reflecting a generally collimated beam of light;
a lens supported by said housing in the path of said collimated beam;
said lens including a faceted array of numerous lens elements in the path of said collimated beam;
said lens elements including a plurality of first lens elements having surfaces for refracting light passing through said first lens elements for redirecting light toward segments of the illuminated region; and
said lens elements including at least one second lens element having an internal surface for reflecting light passing through said second lens element for redirecting light toward another segment of the illuminated region.

10. A method for washing a region of a wall surface with light comprising the steps of:
emitting light from a light source;
reflecting the emitted light in a collimated beam;
refracting portions of the beam to redirect the refracted portions toward segments of the region; and
reflecting another portion of the beam to redirect the reflected portion toward another segment of the region.
